(19) United States
(12) Patent Application Publication
(10) Pub. No.: US 2004/0213882 A1
(43) Pub. Date: Oct. 28, 2004

(54) Use of polydextrose in edible products, edible products containing polydextrose and processes for including polydextrose in edible products

(75) Inventor: Kirsten Lauridsen, Vejle (DE)

Correspondence Address: SCULLY SCOTT MURPHY & PRESSER, PC, 400 GARDEN CITY PLAZA, GARDEN CITY, NY, 11530

(73) Assignee: DANISCO A/S, Copenhagen K (DK)

(21) Appl. No.: 10/787,013

(22) Filed: Feb. 25, 2004

(30) Foreign Application Priority Data
Feb. 26, 2003 (FI) 20030287

(51) Int. Cl. A23L 1/236

(52) U.S. Cl. 426/548

(57) ABSTRACT

The invention relates to the use of polydextrose for the sweetening of edible products. The invention relates especially to the use of polydextrose for synergistically enhancing the sweetness of sweet tasting sugar compounds selected from sucrose, fructose, glucose, lactose, maltose, maltulose, isomaltulose, galactose and mixtures or syrups thereof. The invention provides edible products having a desired level of sweetness with a reduced level of sugar or an enhanced level of sweetness without increased level of sugar. The invention also relates to a process for sweetening an edible product with polydextrose.

### FIELD OF THE INVENTION

The present invention relates to the use of polydextrose for enhancing the sweetness of edible products, especially by synergistically enhancing the sweetness of sugars. The invention relates especially to the use of polydextrose for synergistically enhancing the sweetness of sweet tasting sugar compounds and to edible products having a desired level of sweetness with a reduced level of sugar or an enhanced level of sweetness without increased level of sugar. The invention also relates to a process for sweetening an edible product to a desired level.

### BACKGROUND OF THE INVENTION

Polydextrose is a polysaccharide which was invented in the late 1960's and which is synthesized by random polymerisation of glucose, sorbitol and a suitable acid catalyst at a high temperature and partial vacuum. Polydextrose has been successfully used in the food industry as a bulking agent and as a low-energy ingredient, replacing sugar and partially fat. Polydextrose is not digested or absorbed in the small intestine. It is non-cariogenic and has a caloric value of only 1 kcal/g which makes it highly useful in low calorie foods. Polydextrose has been incorporated into a wide range of foods including baked goods, beverages, confectionery and frozen desserts. Polydextrose is known to provide the bulk and appropriate textural and mouthfeel qualities which are usually associated with sugar and fat while lacking the sweet taste and caloric value connected with those conventional food ingredients.

Polydextrose is known to improve the texture, flavour and aftertaste of many edible products including beverages. Polydextrose is also known to function as a dietary fiber and to have a beneficial effect on the intestinal function of animals, including humans. The use of polydextrose as a prebiotic dietary fiber has been proposed and the beneficial effects of polydextrose on the intestinal tract has been described in the literature (e.g Jie, Z. et al, Am. J. Clin. Nutr. 72, pp. 1503-1509, 2000). Patents relating to the health benefits of polydextrose are, among others, U.S. Pat. No. 5,437,880, JP 2072842 and EP 821885.

Although polydextrose possesses many of the functional properties of sugar, polydextrose itself is not regarded as providing sweetness. When used as a sugar replacement, polydextrose has generally been combined with so called intense sweeteners in order to provide the desired sweet taste in the product in question.

In fact, the prior art such as U.S. Pat. No. 5,059,428 relating to a synergistic combination of polydextrose and an intense sweetener (a chlorodeoxysugar derivative) states that “because Polydextrose is not sweet, sweetening agents such as intense sweetening agents, must be used with Polydextrose to obtain a good tasting edible product.”

Similarly, U.S. Pat. No. 4,631,196, relating to a low cholesterol, low calorie, no fat dairy product which contains a sugar mixture consisting of 10-90% polydextrose and 90 to 10% fructose, states that “the sugar mixture includes polydextrose which is available from the Pfizer Chemical Company and is a reduced calorie (1 calorie per gram) bulking agent which functions like sugar but does not contribute sweetness to the product.” The sweetness of the product is provided in said patent by using fructose instead of sucrose (fructose is about 1.5 times sweeter than sucrose) and by using artificial sweeteners.

Polydextrose has also been combined with sweet tasting polyols such as mannitol, lactitol, maltitol and/or sorbitol, xylitol, isomaltitol, etc. usually in combination with intense sweeteners.

Since polydextrose has been widely used as a sugar and fat substitute, there exists and has existed a large number of edible products containing combinations of polydextrose with sucrose, fructose and other sweet tasting sugar compounds.

Thus, for instance, U.S. Pat. No. 5,262,187 describes a low-fat dry mix containing up to 15% by weight of polydextrose. The polydextrose is used to replace fat in a fat mimetic mixture but there is no indication that any sweetness is contributed by the polydextrose to the mix. The ingredient base of the mix is sweetened by sucrose or fructose. The bakery products produced are described as having a tender mouthfeel and attractive flavour profiles.

EP 259996 describes a sweetening composition containing a dipeptide sweetener, a sweetening enhancing mixture of a polyhydric alcohol and a polycarboxylic acid. Cakes are baked from a mix containing aspartame, fructose, flour, potassium bicarbonate, citric acid, water and egg white and they contain polydextrose and Solk Floc as bulking agents. The sweetness of the cake, which is sweetened with the novel sweetening composition, is said to be equal to a control cake sweetened with fructose.

In none of the prior art mentioned above is there any indication that polydextrose has attributed to the sweetness of the edible product. Quite the contrary, it has been clearly stated that polydextrose is not sweet and that in order to obtain a desired level of sweetness one must use other sweeteners which have a higher level of sweetness so as to compensate for the reduced sweetness provided by substituting a part of the sugar by polydextrose. In fact, a problem encountered with the use of polydextrose as a sugar replacement has been that other and more intense sweeteners than sugar must be used instead.

Consequently, it is highly surprising that polydextrose has been found to have a synergistic sweetness enhancing effect on sweet tasting sugars. This newly found property of polydextrose opens up a host of new uses for polydextrose in combination with sugars in edible products of the most varying kinds. Most surprisingly, the invention enables increasing the sweetness of a product by adding thereto a non-sweet compound like polydextrose. The scope of the present invention is defined in the appended claims.

### SUMMARY OF THE INVENTION

An aspect of the present invention is the use of polydextrose for the sweetening of edible products, and especially for synergistically enhancing the sweetness of a sweet tasting sugar compound in said product. The sugar compounds in question are sweet mono- or disaccharide compounds that are used in sweet edible products. The mono- and disaccharide compounds include, but are not limited to sucrose, fructose, glucose, lactose, maltose, galactose, maltulose, isomaltulose and mixtures thereof.

Another aspect of the invention is an edible product sweetened with polydextrose. The product has a desired level of sweetness with a reduced level of sugar or an increased level of sweetness with a given amount of sugar. The products preferably comprise at least one sweet tasting sugar compound and a synergistically effective amount of polydextrose for enhancing the sweetness of said sugar. The edible product may consist of a mixture of polydextrose and sugar.

A special aspect of the invention is the use of a non-sweet compound for sweetening an edible product which comprises adding polydextrose to an edible product which contains a sweet tasting sugar compound.

A further aspect of the invention is a process for sweetening an edible product with polydextrose. The product may be sweetened to a desired level of sweetness with a reduced amount of sugar. The sweetening is independent of any intense sweeteners that may be used in the product. A preferred process comprises providing in said product a sweet tasting sugar compound and a synergistically effective amount of polydextrose for enhancing the sweetness of said sugar.

An aspect of the invention is also a process for enhancing the sweetness of an edible product which comprises adding to an edible product containing a sweet tasting sugar compound a synergistically effective amount of polydextrose. Yet a further aspect of the invention is a process for sweetening an edible product with a non-sweet compound. The process comprises including a sweetening amount of polydextrose in an edible product comprising a sweet tasting sugar compound.

### DETAILED DESCRIPTION OF THE INVENTION

The present inventor has surprisingly found that a non-sweet compound, polydextrose, can be utilized for sweetening purposes. The novel utilization of polydextrose is based on its synergistic sweetness enhancing effect of certain sugar compounds which are used as sweeteners in edible products. It is indeed most surprising that polydextrose is capable of enhancing the sweetness of sucrose, since polydextrose has heretofore been considered to be a good substitute for sugar except for the sweetness of sugar. On the contrary, the use of polydextrose as a sugar substitute has been considered to render it necessary to add other compounds to compensate for the decreased sweetness provided by the substituting polydextrose.

Now it has become evident that polydextrose, especially purified polydextrose, in actual fact enhances the sweetness of sugars. Therefore, polydextrose can be used either to reduce the amount of sugar used for providing a desired level of sweetness or for increasing the sweetness at a given level of sugar.

The term “polydextrose” as used herein refers to a low calorie polymer of glucose that is resistant to digestion by the enzymes in the stomach. It includes polymer products of glucose which are prepared from glucose, maltose, oligomers of glucose or hydrolyzates of starch, which are polymerized by heat treatment in a polycondensation reaction in the presence of an acid e.g. Lewis acid, inorganic or organic acid, including monocarboxylic acid, dicarboxylic acid and polycarboxylic acid, such as, but not limited to the products prepared by the processes described in the following U.S. Pat. Nos.: 2,436,967, 2,719,179, 4,965,354, 3,766,165, 5,051,500, 5,424,418, 5,378,491, 5,645,647 5,773,604, or 6,475,552, the contents of all of which are incorporated herein by reference.

The term polydextrose also includes those polymer products of glucose prepared by the polycondensation of glucose, maltose, oligomers of glucose or starch hydrolyzates described hereinabove in the presence of a sugar alcohol, e.g. polyol, such as in the reactions described in U.S. Pat. No. 3,766,165. Moreover, the term polydextrose includes the glucose polymers, which have been purified by techniques described in the art, including any and all of the following but not limited to (a) neutralization of any acid associated therewith by base addition thereto, or by passing a concentrated aqueous solution of the polydextrose through an adsorbent resin, a weakly basic ion exchange resin, a type II strongly basic ion-exchange resin, mixed bed resin comprising a basic ion exchange resin, or a cation exchange resin, as described in U.S. Pat. Nos.: 5,667,593 and 5,645,647, the contents of both of which are incorporated by reference; or (b) decolorizing by contacting the polydextrose with activated carbon or charcoal, by slurrying or by passing the solution through a bed of solid adsorbent or by bleaching with sodium chlorite, hydrogen peroxide and the like; (c) molecular sieving methods, like UF, RO (reverse osmosis), size exclusion, and the like; (d) or enzymatically treated polydextrose or (e) any other recognized techniques known in the art. Among the purification processes used in the art the following may be especially mentioned: bleaching, e.g. using hydrogen peroxide (U.S. Pat. No. 4,622,233); membrane technology (U.S. Pat. No. 4,956,458); ion exchange e.g. removal of citric acid (U.S. Pat. No. 5,645,647) or removal of color/bitter taste (U.S. Pat. No. 5,091,015); chromatographic separation, with a strong cation exchanger (WO92/12179); hydrogenation, in combination with ion exchange (U.S. Pat. No. 5,601,863; U.S. Pat. No. 5,573,794) or with ion exchange and chromatographic separation (U.S. Pat. No. 5,424,418); or solvent extraction (U.S. Pat. No. 4,948,596; EP 289 461), the contents of said patents being incorporated by reference.

Moreover, the term polydextrose includes hydrogenated polydextrose, which, as used herein, includes hydrogenated or reduced polyglucose products prepared by techniques known to one of ordinary skill in the art. Some of the techniques are described in U.S. Pat. Nos.: 5,601,863, 5,620,871 and 5,424,418, the contents of which are incorporated by reference. The term polydextrose also encompasses fractionated polydextrose which is a conventional, known material and can be produced e.g. by the processes disclosed in U.S. Pat. Nos. 5,424,418 and 4,948,596 the contents of which are incorporated by reference.

In a preferred embodiment of the invention the polydextrose is purified polydextrose. In another preferred embodiment, the polydextrose used is hydrogenated or reduced polydextrose. Excellent results have been obtained with the invention when the polydextrose used has been both purified and hydrogenated.

The polydextrose may be made substantially pure using conventional techniques known to one skilled in the art, such as chromatography, including column chromatography, HPLC, and the like. Especially for nutraceutical and pharmaceutical use it is preferred that the polydextrose used is at least 80% pure, i.e. at least about 80% of the impurities are removed. More preferably it is at least 85% pure or even more preferably it is at least 90% pure.

Without special purifications polydextrose as produced has a rather acid and sometimes even a bitter taste. Its colour is pale yellow or creamy. It has a natural pH around 2-3 and an acidity which is in the order of 0.1 meq/g. Purification removes acidic and bitter tasting components, reduces the acidity and/or improves the colour towards whiteness. The preferred polydextrose of the present invention is purified in one or more ways so that its pH is increased, its acidity decreased and the taste is less bitter and preferably not at all bitter. The taste of well purified polydextrose is so mild that it is almost like no taste at all.

The preferred polydextrose as used in the present invention is purified to a pH of 3 or more, preferably to 3.5 or more. Most preferably the pH is 4.5 or more. The acidity of the purified polydextrose used in the present invention is preferably 0.05 meq/g or less, more preferably 0.01 meq/g or less most preferably 0.005 meq/g or less.

Polydextrose is commercially available from companies such as Danisco Sweeteners, Staley and Shing Dong Bang. Purified forms of polydextrose are marketed by Danisco Sweeteners under the name Litesse® or Litesse®II and by Staley under the name Stalite III. A reduced form of Litesse® is called Litesse® Ultra. The specifications of the Litesse® polydextrose products are available from Danisco Sweeteners.

The Litesse® polydextroses have an improved taste compared to non-purified polydextrose. Thus, while conventional polydextrose has a tart and acid taste, an acidity of about 0.1 meq/g or more and a pH of 2.5-3.5, Litesse® has a neutral or bland taste, a maximum acidity of 0.03 meq/g and a pH of 3.0-4.5, Litesse® II has a mild and clean taste, a maximum acidity of 0.003 meq/g and a pH of 3.5-5.0, and Litesse® Ultra has a very clean and even mildly sweet taste, a maximum acidity of 0.002 meq/g and a pH of 4.5-6.5.

The term “sweet tasting sugar compound” as used in the present specification and claims indicates a sugar compound which comprises a sweet, water-soluble, crystalline or crystallizing carbohydrate in the form of a mono- or disaccharide. The term excludes various known derivatives of sugars, which are known as artificial or intense sweeteners such as chlorinated deoxy sugar compounds. The term includes but is not limited to sugar compounds such as sucrose, fructose, glucose, lactose, maltose, maltulose, isomaltulose, galactose, etc. and mixtures or syrups thereof. The sugar compound may be added to an edible product or it may be contained in the product itself. Examples of sugars contained in the edible product comprise fructose in fruit and lactose in milk, etc.

The various sugar compounds have different inherent levels of sweetness. Thus, it is generally agreed that on a relative sweetness scale sucrose is the standard with a sweetness of 1.0. Fructose has a sweetness of 1.4-1.8, glucose has a sweetness of 0.8, lactose has a sweetness of 0.2, maltose has a sweetness of 0.45 and galactose has a sweetness of 0.3 compared to sucrose. Polydextrose, on the other hand, is regarded as being non-sweet or as having only a mild sweet taste, which compared to the sweetness of the sugar compounds is negligible. Thus, polydextrose can be considered as being essentially non-sweet.

The term “edible product” as used in the specification and claims is intended to encompass any nutraceutical or pharmaceutical product, which may be safely administered orally to human beings and animals. The edible product of the present invention is characterized by containing a sugar compound and having a sweet taste.

The synergistically effective amount of polydextrose which should be used in relation to the sugar compound varies according to the sugar compound and the type of polydextrose used. The synergistically effective amount of polydextrose is one which significantly enhances the sweetness of a sugar compound or which provides in a product sweetened with a given amount of said sugar a sweetness level equal to one obtainable in said product with the use of a larger amount of sugar or with an intense sweetener.

The ratio of polydextrose to sugar compound also varies with the type of edible product in question and depends on what level of sweetness is desired. The edible products of the present invention preferably have a ratio of polydextrose to sugar in the range of 0.25:1 to 3:1, more preferably in the range of 0.5:1 to 2:1.

It has been found that adding as little as 1 to 3% by weight of purified polydextrose to an edible product sweetened with a sweet tasting sugar compound enhances the sweetness of the product to a more intense sweetness than that of the mere sugar even though the polydextrose itself lacks any significant sweetness. When the amount of polydextrose increases, the mild taste of the polydextrose will gradually mask the sweet taste of the sugar despite the enhanced sweetness provided by the polydextrose. However, the combination will still have a more intense sweetness than that obtainable by a similar amount of non-synergistic bulking agents in combination with the amount of sugar in question.

According to a preferred embodiment of the invention a sweet edible product contains 1 to 40%, preferably 2 to 25% polydextrose calculated on the weight of the final product. The present combination of sugar and a synergistically effective amount of polydextrose may be used in a wide variety of edible products. In fact, the combination may be used in edible products similar to those in which polydextrose has previously been used as a bulking agent, sugar replacement or for some other purpose and which edible product further is characterized by a sweet taste. Such edible products include but are not limited to confectionery such as hard or chewy candy, chocolate, chilled and frozen desserts, dairy products such as milk drinks or cultured dairy products, baked goods, fruit spreads and fillings, surimi, beverages such as beer, sports drinks, etc. The synergistic combination may also be used in pharmaceuticals, especially in pharmaceuticals where the sweet taste of the present combination is useful in masking an unpleasant taste of the pharmaceutical itself.

The sugar and polydextrose may also be used as such in a composition, which consists essentially of a combination of sugar and a synergistically effective sweetness enhancing amount of polydextrose. The composition may be used, for instance, as a low calorie table top sweetener. Such a sweetener preferably contains polydextrose and sugar in a ratio of 0.25:1 to 3:1, more preferably 0.5:1 to 2:1 in order to provide a desired sweetness in an edible product to which it is added. A specific embodiment of the present invention provides a sucrose product containing a combination of sucrose and polydextrose having a sweetness similar to that of conventional sucrose.

In the preferred embodiment, the present sweetness enhanced combination of polydextrose and sugar is, however, used in connection with a nutraceutically or pharmaceutically acceptable carrier or vehicle.

The synergistic sweetness enhancing effect of polydextrose on the sugar may be used in edible products either to reduce the amount of sugar needed to reach a certain level of sweetness in the product, or it may be used to increase the level of sweetness obtainable with a given amount of sugar.

In a preferred embodiment, the synergistic combination is contained in a dairy product. Dairy products, which contain lactose, may be sweetened by merely adding a synergistic amount of polydextrose to said product. For instance, skimmed milk contains about 5% lactose. The polydextrose will enhance the natural sweetness of the lactose and for many purposes the resulting sweetness is sufficient for the product in question. Alternatively, another sweet sugar compound, such as sucrose, fructose, glucose (e.g. glucose syrup), etc. may be added to the dairy product.

The preferred dairy products according to the present invention comprise milk drinks, cultured milk products such as yoghurt, including drinking yoghurt, chilled or frozen milk based desserts, etc. For instance, a preferred milk drink according to the present invention would consist essentially of 86 to 96% milk, 2 to 6% sucrose, fructose, and/or glucose, 2 to 6% purified polydextrose and additionally flavour and/or colour in the order of 0.1 to 0.2%. Of course, a part of the milk may be replaced by water or some other liquid.

The preferred fruit products according to the present invention comprise fruit spreads like jams and marmalades, fruit fillings for bakery products and confectionery, fruit mixes and fruit desserts, frozen fruit desserts such as sorbets, etc. For instance, a preferred jam according to the present invention would contain 20 to 50% fruit, 20 to 50% sucrose, fructose and/or glucose (e.g. glucose syrup), 10 to 50% purified polydextrose, 20 to 50% water, and additionally pectin and/or potassium sorbate in the order of about 1 to 2%. The preferred confectionery products of the invention comprise chocolate and candy, such as toffee, fudge, fondants, chewing gum, hard candy, etc.

In a preferred process according to the invention for sweetening edible products, polydextrose in a synergistically effective amount is included in the product, which contains a sweet tasting sugar compound. The edible product may also contain other sweetening agents but it should be noted that the inventive synergistic sweetening effect is obtained with polydextrose independently of the presence or absence of intense sweeteners in the product.

In a preferred embodiment of the invention, a nutraceutically acceptable carrier or vehicle is admixed with a sweetening composition consisting of a sweet tasting sugar and a synergistically effective sweetness enhancing amount of purified polydextrose.

The amount of polydextrose and sugar which is included in the product depends on the level of sweetness which is desired in the product. In some cases it may be desirable to increase the level of sweetness of a product while retaining the initial amount of sugar in the product. In such cases an effective amount of polydextrose is added to the product to provide the enhanced sweetness. The amount of polydextrose to be added to any specific product can easily be determined by the person skilled in the art without undue need for experimentation.

In other cases it may be desirable to reduce the cariogenic and/or caloric value of a sweet product without reducing its level of sweetness. In such cases polydextrose may substitute the sugar in the product in an amount which by synergy produces the same level of sweetness as the initial amount of sugar.

Polydextrose is known to have a large variety of beneficial effects on the functioning of the body and especially the intestine as mentioned above. Polydextrose also has a beneficial effect on the texture, body and mouthfeel of edible products. The present invention allows the person skilled in the art to take advantage of the well-known taste and health promoting effects of polydextrose in edible products while at the same time additionally improving the sweetness properties of the product.

Persons skilled in the art will be able to utilize the synergistic effect of polydextrose on the sugar in the way, which seems most advantageous in any specific situation.

The edible products sweetened with the polydextrose/sugar composition of the present invention contain the ingredients normally included in the edible product in question, except that the sweetness of the product is adjusted with polydextrose. The processes for manufacturing the sweetened products do not either differ from conventional techniques and the polydextrose and sugar can be added at any conventional and convenient time of the manufacture.

The following examples serve to further illustrate the invention

### EXAMPLE 1

Strawberry flavoured milk drinks were prepared by sweetening milk with sucrose and fructose, respectively. Polydextrose was added to the compositions in order to test its sweetness enhancing effect on the sugars. The polydextroses used were Litesse®II, a purified form of polydextrose available from Danisco Sweeteners, and Litesse® Ultra™, a purified and reduced form of polydextrose available from Danisco Sweeteners. The milk drinks had the following composition

### Milk Drinks Composition with Sweetness Synergy

TABLE 1
(sucrose)

| Composition | 1 | 2 | 3 | 4 | 5 |
|---|---|---|---|---|---|
| Milk | 95.90 | 92.90 | 89.90 | 92.90 | 89.90 |
| Sucrose | 4.00 | 4.00 | 4.00 | 4.00 | 4.00 |
| Litesse ® II | − | 3.00 | 6.00 | − | − |
| Litesse ® Ultra ™ | − | − | − | 3.00 | 6.00 |
| Strawberry flavour | 0.10 | 0.10 | 0.10 | 0.10 | 0.10 |
| Colour | + | + | + | + | + |
| Total | 100.00 | 100.00 | 100.00 | 100.00 | 100.00 |

TABLE 2
(fructose)

| Composition | 1 | 2 | 3 | 4 | 5 |
|---|---|---|---|---|---|
| Milk | 95.90 | 92.90 | 89.90 | 92.90 | 89.90 |
| Fructose | 4.00 | 4.00 | 4.00 | 4.00 | 4.00 |
| Litesse ® II | − | 3.00 | 6.00 | − | − |
| Litesse ® Ultra ™ | − | − | − | 3.00 | 6.00 |
| Strawberry flavour | 0.10 | 0.10 | 0.10 | 0.10 | 0.10 |
| Colour | + | + | + | + | + |
| Total | 100.00 | 100.00 | 100.00 | 100.00 | 100.00 |

The milk drinks, which included polydextrose, were found to have a higher level of sweetness than those without polydextrose. The effect was confirmed in a trained sensory panel at a professional food sensory laboratory. The results are shown in the Tables 3 and 4, respectively. The Tables show by the least significant difference (LSD) that the polydextrose provided a statistically significant increase of the sweetness of the product.

TABLE 3
Mean scores for milk drink sweetened with sucrose and polydextrose

| Attribute | 1 | 2 | 3 | 4 | 5 | LSD |
|---|---|---|---|---|---|---|
| Flavour | | | | | | |
| Overall flavour intensity | 48.1 | 53.0 | 56.0 | 51.9 | 58.9 | ˜6.4 |
| Sweet | 57.9 | 63.6 | 73.1 | 69.3 | 73.8 | *5.9 |
| Sugar | 32.6 | 33.6 | 27.5 | 36.2 | 39.3 | |
| Milk | 45.1 | 44.0 | 47.6 | 44.2 | 45.4 | |
| Mouthfeel | | | | | | |
| Body | 47.3 | 54.6 | 58.5 | 45.1 | 57.0 | |
| Creamy | 16.1 | 22.6 | 22.9 | 16.5 | 20.9 | |
| Aftertaste | | | | | | |
| Sweet | 40.7 | 48.5 | 61.3 | 52.6 | 56.9 | *11.3 |
| Sugar | 14.2 | 17.2 | 20.0 | 18.7 | 19.8 | |
| Milk | 40.6 | 41.0 | 45.2 | 40.7 | 42.6 | |
| Afterfeel | | | | | | |
| Creamy | 15.8 | 18.1 | 18.3 | 13.8 | 17.9 | |

TABLE 4
Mean scores for milk drink sweetened with fructose and polydextrose

| Attribute | 1 | 2 | 3 | 4 | 5 | LSD |
|---|---|---|---|---|---|---|
| Flavour | | | | | | |
| Overall flavour intensity | 45 | 50.3 | 60.1 | 54.7 | 57.6 | |
| Sweet | 53.1 | 64 | 73.2 | 67.6 | 70.4 | *13.1 |
| Sugar | 14.6 | 14.41 | 21 | 17.9 | 19.2 | |
| Milk | 43.5 | 44.8 | 44.7 | 42.9 | 48.4 | |
| Mouthfeel | | | | | | |
| Body | 42.9 | 52.2 | 57.8 | 47.5 | 53.2 | *9.0 |
| Creamy | 14.4 | 16.9 | 18.9 | 16.6 | 18.6 | |
| Aftertaste | | | | | | |
| Sweet | 40.4 | 40.8 | 57.6 | 46.7 | 51.6 | *7.2 |
| Sugar | 13.5 | 11.6 | 19.2 | 12.9 | 17 | |
| Milk | 38.7 | 38.5 | 39.6 | 38.2 | 40.1 | |
| Afterfeel | | | | | | |
| Creamy | 10.3 | 12.1 | 13.1 | 12.7 | 13.1 | |

The sensory panel found that the samples with polydextrose were significantly sweeter than the samples, which did not contain polydextrose. The test very clearly shows that polydextrose has a synergistic sweetening effect on the sugar compounds in the product.

### EXAMPLE 2

A conventional blackcurrant jam was prepared from frozen berries and it was sweetened with fructose and with a combination of fructose and polydextrose, respectively. The polydextrose used was Litesse®II, a purified form of polydextrose available from Danisco Sweeteners. The jam had the composition shown in Table 5.

### Jam with Sweetness Synergy

TABLE 5

| Composition | 1 | 2 |
|---|---|---|
| Grindsted Pectin LA 410 | 0.80 | 0.50 |
| Fructose, 1 | 1.00 | 1.00 |
| Water 1 | 10.00 | 10.00 |
| Blackcurrants, frozen | 35.00 | 35.00 |
| Fructose, 2 | 39.00 | 39.00 |
| Litesse ® II | — | 20.00 |
| Water 2 | 15.00 | — |
| K-sorbate, 20% w/v | 0.25 | 0.25 |
| Total | 101.05 | 105.75 |
| Evaporation | 1.05 | 5.75 |
| Yield | 100.00 | 100.00 |
| SS % | 42.95 | 61.85 |

The jam sweetened with polydextrose had a significantly higher level of sweetness than the jam without polydextrose.

### EXAMPLE 3

Skimmed milk was sweetened with only polydextrose (Litesse ®II, Danisco Sweeteners) without adding any separate sweetener to the drink. Skimmed milk contains about 5% lactose.

The mixtures and the tastes provided by the mixtures are indicated below in Table 6.

TABLE 6

| Mixture | Taste |
|---|---|
| Skimmed milk alone | Bland |
| Skimmed milk with | Slightly sweet throughout which increased at the |
| 3% Litesse ® II | end, less clean than 3% Litesse ® Ultra ™ |
| Skimmed milk with | Sweet throughout |
| 6% Litesse ® II | |
| Skimmed milk with | Slight sweetness at finish but still clean milk taste |
| 3% Litesse ® Ultra ™ | |
| Skimmed milk with | Mildly sweet but can still taste milk - a clean taste |
| 6% Litesse ® Ultra ™ | |

The results indicate that the sweetness of lactose in the skimmed milk was enhanced by the polydextrose.

Above, the invention has been illustrated with some examples of the sweetening effect of polydextrose on containing sugar compounds in edible products. A person skilled in the art will be able to utilize the invention in various ways without deviating from the scope of the appended claims.

1. The use of polydextrose for enhancing the sweetness of an edible product.

2. The use according to claim 1, wherein said edible product contains a sweet tasting sugar compound selected from sweet, water-soluble, crystalline or crystallizing carbohydrates in the form of mono- or disaccharides.

3. The use according to claim 2, wherein sweet tasting sugar compound is selected from the group consisting of sucrose, fructose, glucose, lactose, maltose, maltulose, isomaltulose, galactose and mixtures or syrups thereof.

4. The use according to claim 3, wherein said sugar compound is selected from sucrose, fructose, glucose, lactose and mixtures or syrups thereof.

5. The use according to claim 2 wherein said polydextrose is used for synergistically enhancing the sweetness of said sugar compound.

6. The use according to claim 1, wherein said polydextrose is selected from the group consisting of purified polydextrose, hydrogenated polydextrose, a fractionated form of unpurified or purified polydextrose and mixtures thereof.

7. The use according to claim 6, wherein said polydextrose is selected from purified polydextrose and purified and hydrogenated polydextrose.

8. The use according to claim 6 or 7 wherein, said polydextrose is at least 80% pure, preferably at least 85% pure, most preferably at least 90% pure.

9. The use according to claim 6, wherein said polydextrose comprises purified polydextrose having a pH of 3 or more, preferably a pH of 3.5 or more, most preferably a pH of 4.5 or more.

10. The use according to claim 9, wherein the acidity of the polydextrose is 0.05 meq/g or less, preferably 0.01 meq/g or less, more preferably 0.005 meq/g or less.

11. The use according to claim 9, wherein said polydextrose has a mild and clean taste and a pH between 3.5 and 6.5 and an acidity of 0.003 meq/g or less.

12. The use according to claim 1, wherein said edible product is selected from the group consisting of a dairy product, a fruit product, a bakery product, a confectionery product, a dessert, a beverage, a table top sweetener and a pharmaceutical product.

13. The use according to claim 3 or 4, wherein the ratio of said polydextrose to said sugar compound is from 0.25:1 to 3:1, preferably 0.5:1 to 2:1.

14. An edible product having a sweet taste and comprising an effective sweetening amount of polydextrose.

15. The edible product according to claim 14, wherein said edible product comprises a sweet tasting sugar compound selected from sweet, water-soluble, crystalline or crystallizing carbohydrates in the form of mono- or disaccharides.

16. The edible product according to claim 15, wherein sweet tasting sugar compound is selected from the group consisting of sucrose, fructose, glucose, lactose, maltose, maltulose, isomaltulose, galactose and mixtures or syrups thereof.

17. The edible product according to claim 16 wherein said product contains polydextrose in an effective synergistically enhancing amount for enhancing the sweetness of said sugar compound.

18. The product according to claim 17, wherein said synergistically effective amount of polydextrose is one which provides in a product sweetened with a given amount of said sugar a sweetness level equal to one obtainable in said product with the use of a larger amount of sugar or an intense sweetener.

19. The edible product according to claim 14, wherein said polydextrose is selected from the group consisting of purified polydextrose, hydrogenated polydextrose, a fractionated form of unpurified or purified polydextrose and mixtures thereof.

20. The edible product according to claim 19, wherein said polydextrose is purified and/or hydrogenated polydextrose.

21. The edible product according to claim 16 having a desired level of sweetness with a reduced level of sugar independently of other sweeteners, said product comprising a reduced level of at least one of said sweet tasting sugar compounds and a synergistically effective amount of polydextrose for enhancing the sweetness of said sugar compound.

22. The edible product according to claim 16 having an increased level of sweetness with a given amount of sugar independently of other sweeteners, said product comprising at least one of said sweet tasting sugar compounds and a synergistically effective amount of polydextrose for enhancing the sweetness of said sugar compound.

23. The edible product according to claim 21 or 22, wherein said sugar compound is sucrose having a sweetness of 1.0 and said polydextrose enhances the sweetness of said sucrose to a sweetness greater than 1.0.

24. The edible product according to claim 21 or 22, wherein said sugar compound is fructose having a sweetness of 1.5 and said polydextrose enhances the sweetness of said fructose to a sweetness greater than 1.5.

25. The edible product according to claim 15, wherein said product comprises a sweetening composition consisting essentially of at least one of said sweet tasting sugar compounds and a synergistically effective sweetness enhancing amount of polydextrose.

26. The edible product according to claim 25, wherein said product comprises a low calorie table top sweetener consisting of a mixture of sucrose and polydextrose and having a sweetness similar to conventional sucrose.

27. The edible product according to claim 14, wherein said product comprises at least one nutraceutically acceptable carrier or vehicle in admixture with said sweet tasting sugar compound and a synergistically effective sweetness enhancing amount of polydextrose.

28. The edible product according to claim 27, wherein said product is selected from the group consisting of a dairy product, a fruit product, a bakery product, a confectionery product, a dessert, a beverage and a pharmaceutical product.

29. The edible product according to claim 28, wherein said dairy product comprises a milk drink, a cultured milk product such as yoghurt, or a chilled or frozen milk based product.

30. The edible product according to claim 29, wherein said product comprises a milk drink consisting essentially of 86 to 96% milk, 2 to 6% sucrose, fructose or glucose, 2 to 6% purified polydextrose and less than 1% flavour and/or colour.

31. The edible product according to claim 28, wherein said fruit product comprises a jam, a marmalade, a fruit filling, a fruit mix or a fruit dessert.

32. The edible product according to claim 28, wherein said confectionery product comprises a chocolate, a toffee, a fudge, a fondant, a chewing gum or a hard candy.

33. The edible product according to claim 27, wherein said product contains 1 to 40%, preferably 2 to 25% purified polydextrose calculated on the weight of the final product.

34. A process for sweetening an edible product comprising including an effective sweetening amount of polydextrose in said edible product.

35. The process according to claim 34, wherein a sweet tasting sugar compound selected from sweet, water-soluble, crystalline or crystallizing carbohydrates in the form of mono- or disaccharides is provided in said product.

36. The process according to claim 35, wherein said sweet tasting sugar compound is selected from the group consisting of sucrose, fructose, glucose, lactose, maltose, maltulose, isomaltulose, galactose and mixtures or syrups thereof.

37. The process according to claim 34, wherein said polydextrose is selected from the group consisting of purified polydextrose, hydrogenated polydextrose, a fractionated form of unpurified or purified polydextrose and mixtures thereof, preferably purified and/or hydrogenated polydextrose.

38. The process according to claim 34, wherein purified polydextrose is added to said edible product in an amount of at least 1%, preferably at least 3%, calculated on the weight of the final product.

39. The process according to claim 35, wherein said edible product is sweetened to a desired level of sweetness with a reduced amount of said sugar compound or to a more intense level of sweetness with a given amount of said sugar compound, independently of intense sweeteners by providing in said product a synergistically effective amount of said polydextrose for enhancing the sweetness of said sugar compound.

40. The process according to claim 34, wherein a nutraceutically acceptable carrier or vehicle is admixed with a sweetening composition consisting of at least one of said sweet tasting sugar compounds and a synergistically effective amount of said polydextrose.

41. A process for sweetening an edible product with a non-sweet compound, which comprises including a synergistically sweetening amount of purified and/or hydrogenated polydextrose in an edible product comprising a sweet tasting sugar compound selected from the group consisting of sucrose, fructose, glucose, lactose, maltose, maltulose, isomaltulose, galactose and mixtures or syrups thereof.

42. A process for enhancing the sweetness of an edible product, comprising including a synergistically sweetening amount of purified and/or hydrogenated polydextrose in an edible product comprising a sweet tasting sugar compound selected from the group consisting of sucrose, fructose, glucose, lactose, maltose, maltulose, isomaltulose, galactose and mixtures or syrups thereof.
